(19) United States
(12) Patent Application Publication
(10) Pub. No.: US 2009/0283225 A1
(43) Pub. Date: Nov. 19, 2009

(54) Apparatus, System, and Method for Combining a Retractable Shade with a Drapery Rod

(76) Inventor: Timothy Luger, Park City, UT (US)

Correspondence Address: Kunzler & McKenzie, 8 EAST BROADWAY, SUITE 600, SALT LAKE CITY, UT, 84111, US

(21) Appl. No.: 12/426,728

(22) Filed: Apr. 20, 2009

Related U.S. Application Data
(60) Provisional application No. 61/053,572, filed on May 15, 2008.

(51) Int. Cl. E06B 9/72; A47B 96/06; E06B 9/68; H04L 17/02

(52) U.S. Cl. 160/310; 248/205.1; 160/309; 160/405; 341/176

(57) ABSTRACT

An apparatus, system, and method for combining a retractable shade with a drapery rod include an outer rod and an inner rod rotatably supported on an interior of the outer rod. A motive mechanism is supported on an interior of the outer rod external to the inner rod for rotating the inner rod relative to the outer rod. A fabric is coupled to the inner rod. The outer rod has a slot through which the fabric extends and retracts. When the blind is in a retracted condition, the drapery rod conceals the blind. Thus, the drapery rod is a monolithic combination drapery rod. The motive mechanism may include a motor. The blind may be moved by operation of the motor through a wired or wireless connection. A drapery may be movably supported on the outer rod. In another embodiment, a separate decorative drapery rod conceals a motorized drapery rod within.

### BACKGROUND OF THE INVENTION

1. Field of the Invention

This invention relates generally to window treatments, and more particularly relates to draperies and blinds.

2. Description of the Related Art

Traditional drapery rods perform a useful function in providing a platform upon which curtain may be mounted and slide smoothly. Drapery rods are also generally designed to have an aesthetic appeal. The drapery rod is generally formed as a tube that supports rings or other structure which in turn support the draperies.

Blinds are a separate type of window covering. Blinds have been used for years to cover windows and they are generally used as an alternative to drapes. Sometimes, however, and in particular when motorized blinds are used, drapes are occasionally used together with the motorized blinds. In such situations, the motorized blinds are attached separate of the drapes and the drapery rods. Such a situation lacks in aesthetics and in cost savings.

### SUMMARY OF THE INVENTION

From the foregoing discussion, it should be apparent that a need exists for an apparatus, system, and method for combining a retractable shade or screen with a drapery or curtain rod. Beneficially, such an apparatus, system, and method would combine a shade with the draperies while providing greater aesthetics and cost savings.

The present invention has been developed in response to the present state of the art, and in particular, in response to the problems and needs in the art that have not yet been fully solved by currently available apparatuses and techniques. Accordingly, the present invention has been developed to provide an apparatus, system, and method for combining a retractable shade or screen with a drapery or curtain that overcome many or all of the shortcomings in the art.

In a simple form, embodiments of the invention include an apparatus for combining a drapery rod and a roller blind. The apparatus is provided with a drapery rod having an outer tube adapted to receive slidable hanging elements for supporting a drapery. The apparatus is also provided with an inner tube or rod rotatably supported within the outer tube. The inner tube is adapted to have a rollable fabric connected thereto. The apparatus also has an electric motor supported on an inside of the outer tube and motively engaging the inner tube to rotate the inner tube relative to the outer tube during operation.

In one embodiment, the apparatus includes a receiver disposed within the outer tube and operably connected to the motor. Thus, in this embodiment, the control uses a wireless portable remote control device with a transmitter and switches therein for communication with the receiver.

In one embodiment of the apparatus, the drapery rod is a first drapery rod. The apparatus may further include a second drapery rod supported adjacent to the first drapery rod. The second drapery rod may have slidable hanging elements for supporting a drapery. In this case, the inner tube may be a first inner tube. The apparatus may further include a second inner tube concealed within the second drapery rod and the second inner tube may slidably support the slidable hanging elements. The second drapery rod may be a motorized drapery rod. The mounting brackets may be coupled to and support the first and second drapery rods in order to mount the first and second drapery rods to a wall.

In another simple form, embodiments of the invention include a system for movably supporting a drapery and a rollable blind on a combination drapery rod. The system includes an outer tube supporting a driving mechanism and an inner tube on an interior of the outer tube. The outer tube has a slot extending from the interior to an exterior of the outer tube along a length of the outer tube. The inner tube has a fabric attached thereto for extending through the slot. The inner tube is drivably coupled to the driving mechanism and forms a retractable blind within the outer tube. The outer tube is adapted to slidably receive drapery-supporting elements. Thus, the combination drapery rod forms a monolithic combination drapery rod that has the appearance of a conventional drapery rod for supporting slidable hanging elements of a drapery while housing the drive mechanism, the inner tube, and the fabric forming the retractable blind.

In one embodiment, the slidable drapery-supporting elements are received on the outer tube. In another embodiment, the outer tube is a first outer tube, and the system includes a second outer tube on which the slidable drapery-supporting elements are received. In this case, the second outer tube may be supported adjacent to the first outer tube. Also, the inner tube may be a first inner tube and the system may further include a second inner tube on an interior of the second outer tube. The second inner tube may include a channel slidably supporting the drapery-supporting elements.

The present invention also includes a method for deploying and retracting a blind. The method includes concealing a blind within a drapery rod when the blind is in a retracted position. The method also includes moving the blind within a drapery rod in response to user input. In one embodiment, concealing and moving are independent of opening and closing draperies associated with the blind. In one embodiment, the method includes supporting the draperies on the drapery rod. In another embodiment, the method includes supporting the draperies on a separate drapery rod. In some embodiments, concealing and moving are dependent on at least one of opening, closing, and moving draperies supported on the drapery rod. In other embodiments, moving the draperies is dependent on at least one of extending, concealing, retracting, and moving the blind.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic perspective view illustrating one embodiment of a combination drapery rod system in accordance with the present invention;

FIG. 2 is a schematic exploded perspective view of a combination drapery rod apparatus in accordance with the embodiment of FIG. 1 with several components that are supported on an interior of the drapery rod;

FIG. 3 is a schematic exploded perspective view of a motive mechanism portion of a drapery rod apparatus in accordance with an alternative embodiment of the present invention;

FIG. 4 is a partial perspective view of the drapery tube with a slot and through opening for accommodating the blind and motive mechanism in accordance with the embodiment of FIG. 3;

FIG. 5 is an exploded partial perspective view of a combination drapery rod showing additional or alternative details in accordance with an embodiment of the present invention;

FIG. 6 is a detailed perspective view of a region 6 of FIG. 5;

FIG. 7 is a detailed perspective view of a region 7 of FIG. 5;

FIG. 8 is a detailed perspective view showing components from FIGS. 6 and 7 in their partially assembled condition;

FIG. 9 is a detailed perspective view of a portion of FIG. 7 including a motor and blind rod in an assembled condition;

FIG. 10 is a perspective end view of the motor installed in an interior of a drapery tube;

FIG. 11 is a detailed exploded partial perspective view of an end of the combination drapery rod of FIG. 5 showing an end opposite the end shown in FIGS. 5-10;

FIG. 12 is a detailed perspective view of the end of the combination drapery rod shown in FIG. 11 with the combination drapery rod mostly assembled;

FIG. 13 is a perspective end view of a bearing and bearing base;

FIG. 14 is a partial perspective view of a system similar to the system shown in FIG. 1 and having the blind in a partially extended position;

FIG. 15 is a side perspective view of a region 15 of FIG. 14 showing a relationship between a drapery with its C-hooks, the drapery tube with its slot, and the blind extending from the slot;

FIG. 16 is a diagrammatic sectional view taken along line 16-16 of FIG. 13;

FIG. 17 is a schematic block diagram illustrating one embodiment of a method in accordance with the present invention; and

FIG. 18 is a bottom perspective view of a drapery tube and a blind tube supported one in front of another by a combination bracket.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagram included herein are generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

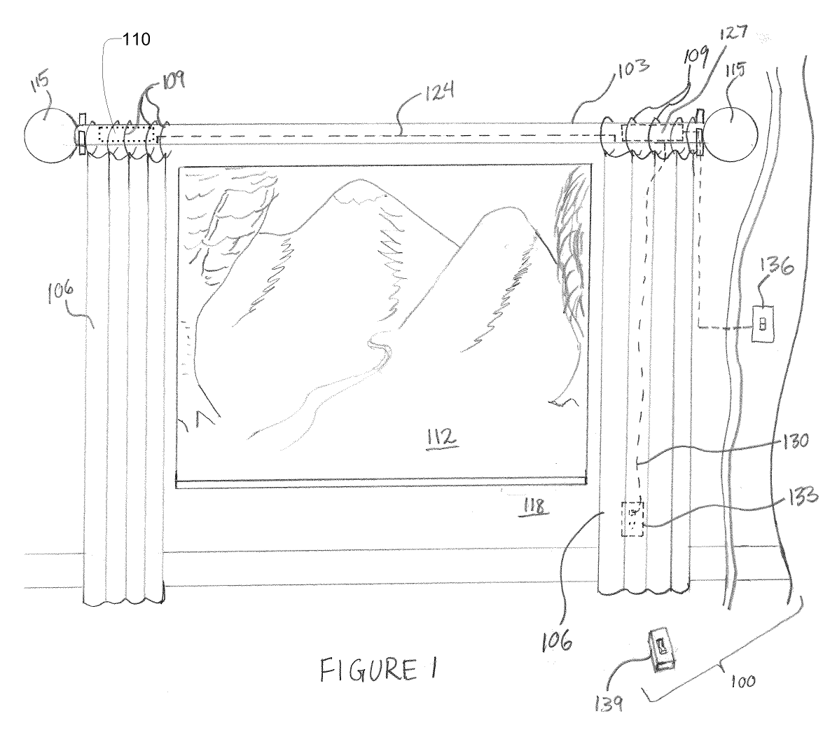

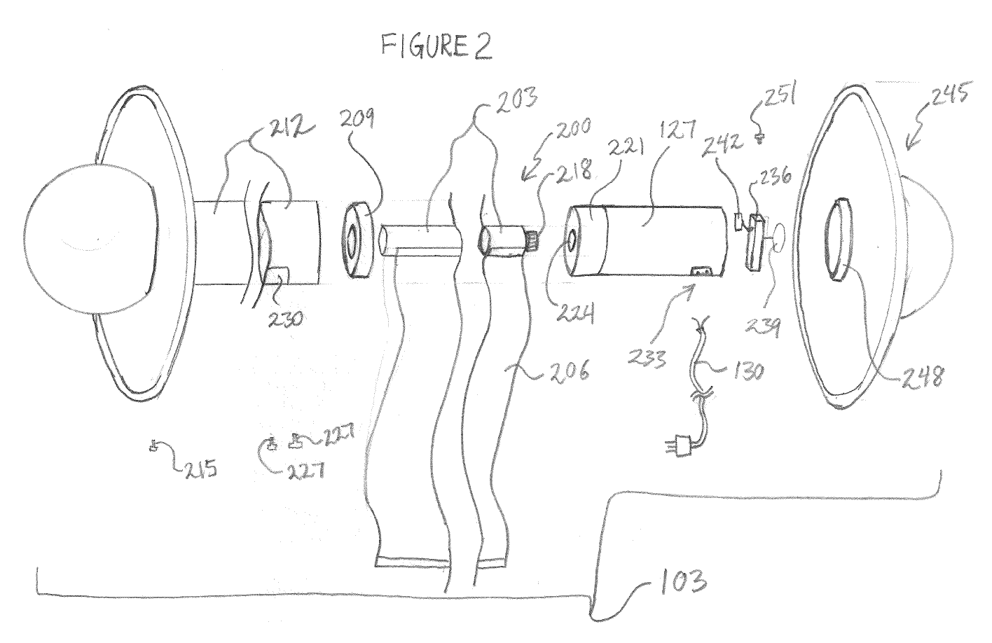

FIG. 1 is a schematic perspective view of a system 100 that includes a combination drapery rod 103 in accordance with embodiments of the present invention. The system enables a drapery 106, which may be hung from the drapery rod 103, to be combined with a blind (shown and described with regard to FIGS. 2-17) in a single apparatus 103. For example, the draperies 106 may be slidably supported on the combination drapery rod 103 by C-rings 109 for manual or automated sliding motion. In the automated drapery embodiments, the draperies may be moved by a belt that is energized by a motor 110 or by another automatic or semi-automatic mechanism that has a degree of mechanical advantage. The draperies are thus capable of covering a window 112, painting, or simply a wall. Furthermore, the combination drapery rod 103 may be an ornamental drapery rod that has aesthetic design features such as ornamental end caps 115, which may be selected from any of a variety of ornamental designs. The combination drapery rod may be supported on a wall 118 by an attachment mechanism, which may take the form of mounting brackets 121.

In addition to providing a support for draperies, the combination drapery rod 103 also supports a blind rod in an interior of the combination drapery rod 103. The combination drapery rod 103 may have a slot 124 opening out through a bottom and back face, as indicated by a dashed line in FIG. 1, for passage of a fabric during extension and retraction of the blind. As shown in FIG. 1, the combination drapery rod 103 may shroud, conceal, or at least partially conceal the blind when the blind is in a retracted condition within the combination drapery rod 103.

motor 127 (shown schematically in dashed lines) is also supported on an interior of the combination drapery rod 103. A power line for the motor 127 may be wired through a wall with other electrical wiring of the building, or may be connected by a conventional cord 130 to a plug 133 of a wall socket 133. In this case, the drapery 106 may help to conceal or shroud the cord 130. A user interface may include an in-wall switch 136 connected by wires or wirelessly to the motor 127. Alternatively or additionally, a hand-held remote control device 139 may be utilized for ease of extending the blind from within the combination drapery rod 103 or retracting it once it has been extended. The in-wall switch and/or the hand-held device may include a rocker switch with a neutral off position, an up position, and a down position. The rocker switch may be spring-loaded such that when no pressure is applied, the switch returns to its neutral off position. The in-wall switch 136 and/or the hand-held remote control device 139 may also have controls for moving the draperies 106 if the blind is automated. In one embodiment, the blind can be operated independently of a position or movement of the draperies 106. In another embodiment operation of the blind is dependent on one of a position and movement of the draperies. In general, there are embodiments in which operations of the blind and draperies are mutually dependent on each other and there are embodiments in which each of the blind and draperies can be operated independently of the operation and position of each other.

FIG. 2 is a schematic exploded perspective view of the combination drapery rod 103 of FIG. 1 showing a blind 200 including an inner rod or tube or blind rod 203, a fabric 206 of the blind, motive mechanism in the form of the motor 127, and a bearing 209. The bearing 209 rotatably supports one end of the blind rod 203 and reduces friction as the blind rod is rotated during extension and retraction of the fabric 206 by rolling off and onto the blind rod 203. For this purpose, the bearing is received into an outer tube or drapery tube 212 and may be secured therein by a screw 215. A toothed member 218 may be fixed on an opposite end of the blind rod 203 for engagement by the motive mechanism. A gear reduction mechanism or gear box 221 may interconnect the blind rod 203 with the motor 127 in order to provide an appropriate speed of rotation for the blind rod 203 when the motor 127 is run at a predetermined speed. Thus, the toothed member 218 may engage in a socket 224 of the gear box 221 for engagement with a gear (not shown) in the gear box 221.

The fabric 206 may be rolled onto the blind rod 203. The blind rod 203, the fabric 206, the gear box 221, and the motor 127 may be assembled and inserted into the drapery tube 212. The motor 127 and gear box 221 may be secured in the interior of the drapery tube 212 by screws 227 extending through threaded holes in the drapery tube 212 and into engagement with the motor 127 and/or the gear box 221, for example. Another through hole 230 in the drapery tube 212 may be provided to allow for passage of the power cord 130 through the drapery tube 212 and connection of wires of the power cord 130 to appropriate terminals 233 of the motor 127. An ornamental end cap 245 may have a flange 248 sized to be inserted into an end of the outer or drapery tube 212 in a snug fit, and may be secured thereto by one or more screws 251.

The motor may have electronic controls 236 associated therewith to effectuate turning the motor 127 on and off in general, and in particular to select a direction of rotation for the motor 127 in one of first and second directions. Alternatively or additionally, the electronic controls 236 may enable adjustment of the speed of the motor 127. The electronic controls 236 may include a receiver that receives radio frequency or other wireless signals from a transmitter located at the in-wall switch 136 and/or in the hand-held remote control device 139 illustrated in FIG. 1. An antenna 239 may aid in receiving the signals. The electronic controls 236 may be connected to terminals on the motor 127 by a connector 242. Thus, the motor 127 may be controlled by the in-wall switch 136 and/or by the remote control device 139 to move the blind 200 in an extension direction, a retraction direction, or to stop movement of the blind 200 relative to the drapery tube 212.

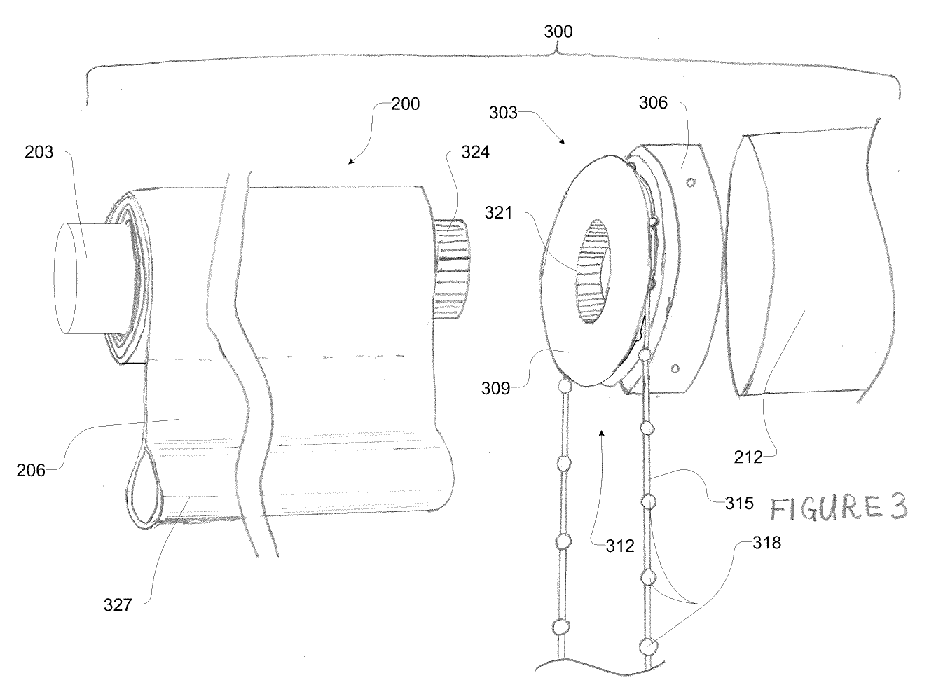

FIG. 3 is a diagrammatic exploded partial perspective view of a hand crank assembly 300 showing an alternative motive mechanism in the form of a hand crank 303, which in this embodiment replaces the motor described above. Generally, a hand crank base 306 is sized slightly smaller than the drapery tube 212 such that during assembly the hand crank 303 may be slid into position within the drapery tube 212 and secured by set screws extending through the drapery tube 212 and engaging the hand crank base 306. The hand crank 303 also has a pulley wheel 309 rotatably supported on the base 306. The pulley wheel 309 has a shaped groove 312 that receives a chain or endless cord 315. The endless cord 315 has balls 318 or other structure for engaging complementary structure within the shaped groove 312. The balls 318 and complementary structure inhibit relative movement between the endless cord 315 and the pulley wheel 309 along a length of the endless cord 315. Thus, the endless cord 315 may be manually engaged and pulled in order to rotate the pulley wheel 309, which in turn causes the blind rod 203 to rotate. As may be appreciated, the drapery tube 212 is provided with a cutout (not shown in FIG. 3) at an appropriate location to enable the endless cord 315 to hang and extend through the cutout without interference.

The pulley wheel 309 may have a toothed socket 321 disposed therein for receiving a toothed member 324 in complementary non-rotatable engagement. Thus, when the blind 200 is assembled together with the hand crank 303 and installed in an interior of the drapery tube 212, the toothed member 324 engages the toothed socket 321. A bearing similar to the bearing 209 described above may receive an end of the blind rod 203 opposite an end having the toothed member 224 and may function similarly to the bearing 209 in order to facilitate reduced-friction rotation of the blind rod 203 within the drapery tube 212. In this way, a user can easily grasp the endless cord 315 and manually pull it in one direction or another to effectuate extension and retraction of the fabric 206, which is secured to and rolled onto the blind rod 203. A hem weight 327 is secured to an outer edge of the role of fabric 206 and exerts a moderate force under the influence of gravity that causes the fabric 206 hang down, and to be deployed and retracted generally in a vertical plane when a motive mechanism is activated to extend or retract the blind 200. It is to be understood that the drapery tube 212 has a slot (not shown in FIG. 3) opening from the interior to an exterior along a length of the drapery tube 212 to accommodate passage of the fabric 206 therethrough during extension and retraction of the blind 200, as will be described in greater detail below.

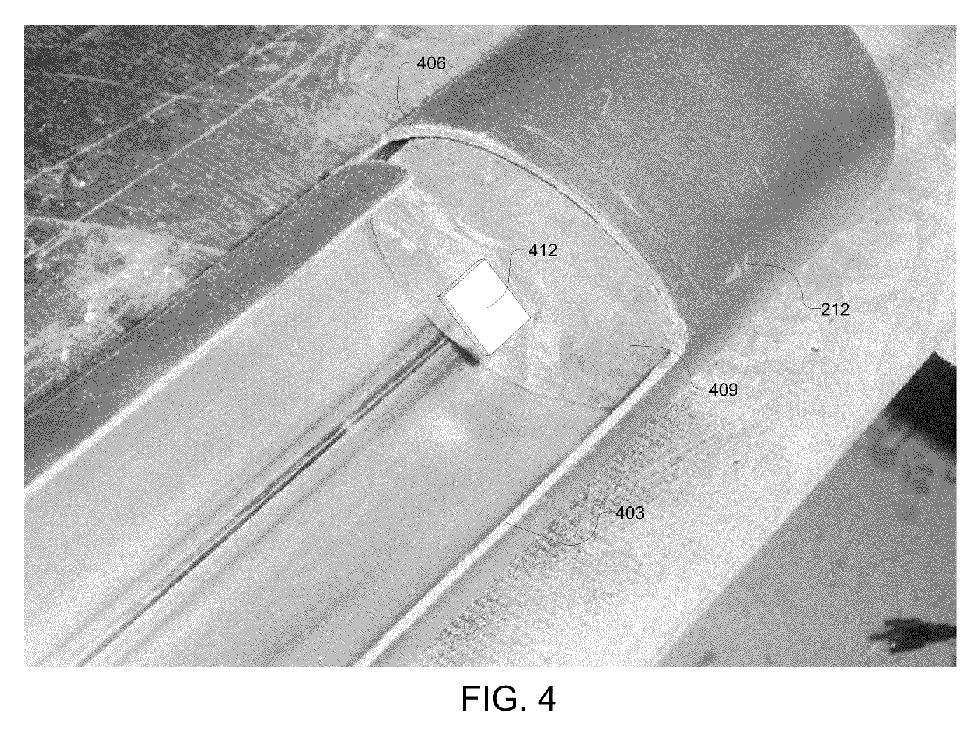

FIG. 4 is a bottom-rear perspective view of the drapery tube 212 in accordance with the embodiment of FIG. 3. As shown, the drapery tube 212 has a slot 403 opening from an interior of the drapery tube 212 through a bottom-rear wall of the drapery tube 212. In this embodiment, a cut out 406 is an extension of the slot 403 and accommodates the endless cord 315 shown and described with regard to FIG. 3. An end wall 409 may be secured on an interior of the drapery tube 212 and form an abutment for the base 306 of the hand crank 303 shown in FIG. 3. A protrusion 412 on the end wall 409 may engage mating structure on the base 306 to inhibit rotational movement of the base 306 relative to the end wall 409.

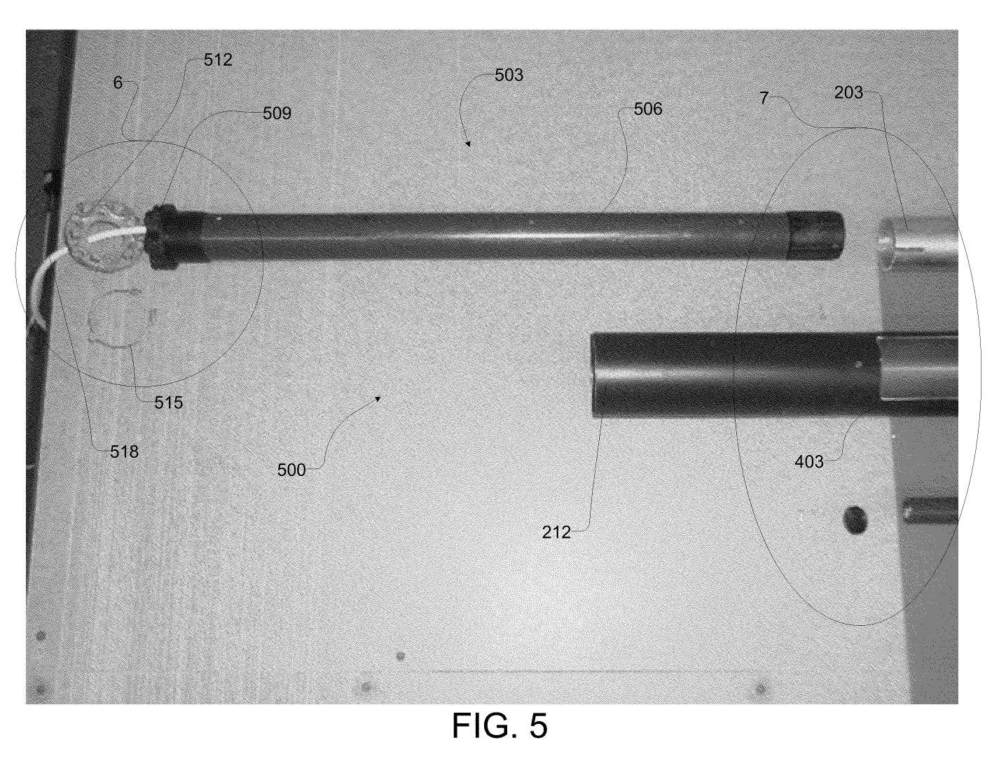

FIG. 5 is an exploded partial perspective view of a combination drapery rod 500 in accordance with another embodiment of the present invention in which similar elements are numbered the same as in the description of FIGS. 1-5. For example, the combination drapery rod 500 includes a drapery tube 212 with a slot 403 that have structure and function similar to the combination drapery rod described above. Likewise, the combination drapery rod 500 has a blind tube or blind rod 203 similar to the blind rod described above. On the other hand, the combination drapery rod 500 has a motor 503 with a housing 506 that is received and secured within an interior of the blind rod 203 in a manner such as by set screws. On the other hand, a head 509 that is rotatable relative to the housing 506 is secured to the drapery tube 212 on an inside surface of the drapery tube 212 by a head bracket 512 and a locking spring pin 515. A power cord 518 may extend through an end wall or a sidewall of the drapery tube 212 to connect to a power source and supply electricity to the motor 503. As may be appreciated, with the housing 506 secured to the blind rod 203 and the head 509 secured to the drapery tube 212, running the motor will causer relative motion between the blind rod 203 and the drapery tube 212.

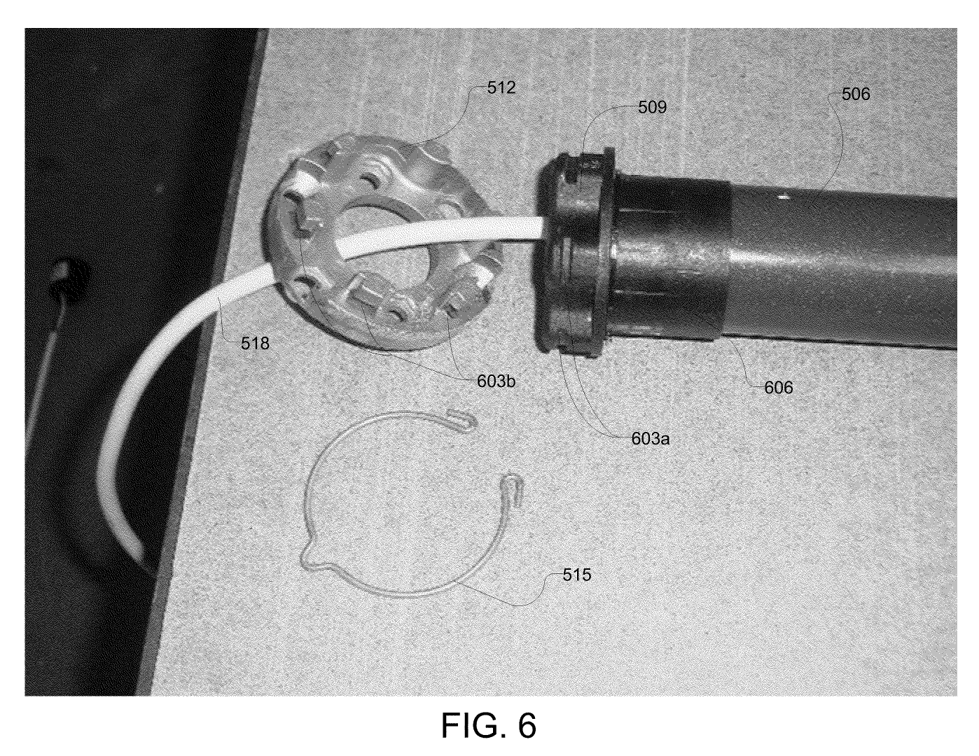

FIG. 6 is a detailed perspective view of a region 6 encircled in FIG. 5. This view shows complementary structure on the head 509 and the head bracket 512 that when engaged inhibits relative rotational movement between the head 509 and the head bracket 512. Once the bracket 512 has been assembled on the head 509, the spring pin 515 may be placed in a groove 603a, 603b formed by the head 509 and bracket 512 together. The head 509 is fixed relative to a core of the motor 503 and rotates relative to the housing 506 of the motor 503 when the motor 503 is operated. The head 509 is adjacent to and rotatable relative to a neck that forms a first end cap 606 on the motor housing 506. The first end cap 606 is formed of a material and/or has structural elements that facilitate securing the first end cap 606 to an interior of the blind rod 203 (not shown in FIG. 6).

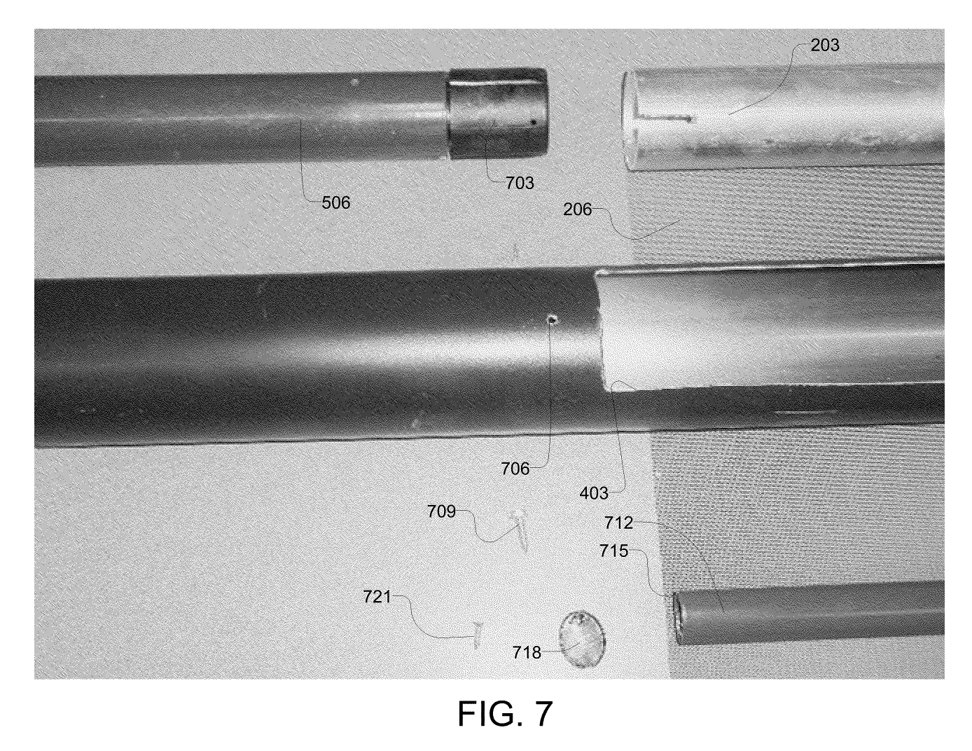

FIG. 7 is a detailed perspective view of a region 7 outlined in FIG. 5 showing a second end cap 703 on the motor housing 506. Like the first end cap 606, the second end cap 703 has a material and/or structural elements that facilitate securing the second end cap 703 to the interior of the blind rod 203. The drapery tube 212 is provided with the slot 403 for extension and retraction of the blind 200, a hole 706, and a screw 709 for securing the head bracket 512 and/or the head 509 (shown in FIG. 6) to an interior of the drapery tube 212. Other coupling mechanisms may be utilized instead of or in addition to those shown and described herein. Also shown in FIG. 7 is the fabric 206 extending behind and attached along one of the edges of the fabric 206 to the blind rod 203. A hem weight 712 is shown overlying the fabric 206 in its unassembled condition. In order to assemble the hem weight 712 on the fabric 206, an edge of the fabric 206 together with a stiffener (not shown) coupled to the edge of the fabric 206 is inserted into a groove 715 in the hem weight 712. An end plate 718 is secured to a longitudinal end of the hem weight 712 by a screw 721.

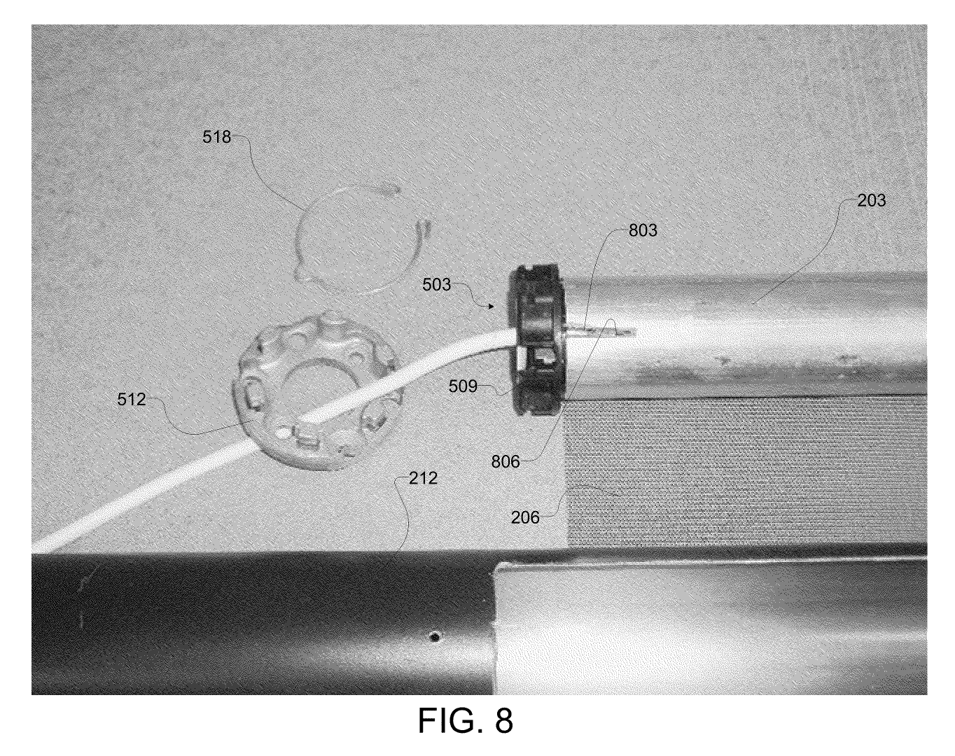

FIG. 8 is a detailed partially exploded perspective view similar to FIGS. 5 and 6 and having the motor 503 inserted into the blind rod 203. The motor 503 is secured at least in part by a clip 803 removably coupled to structure on the first end cap 606 (shown in FIG. 6). The clip 803 engages in a slot 806 and inhibits rotation of the motor housing 506 relative to the blind rod 203. The clip 803 and/or other structure can be used to inhibit inadvertent separation of the motor 503 from the interior of the blind rod 203. In the partially assembled condition shown in FIG. 8, the combination drapery rod 500 is at a stage of assembly at which the head bracket 512 can be secured to the head 509 by the locking spring pin 515.

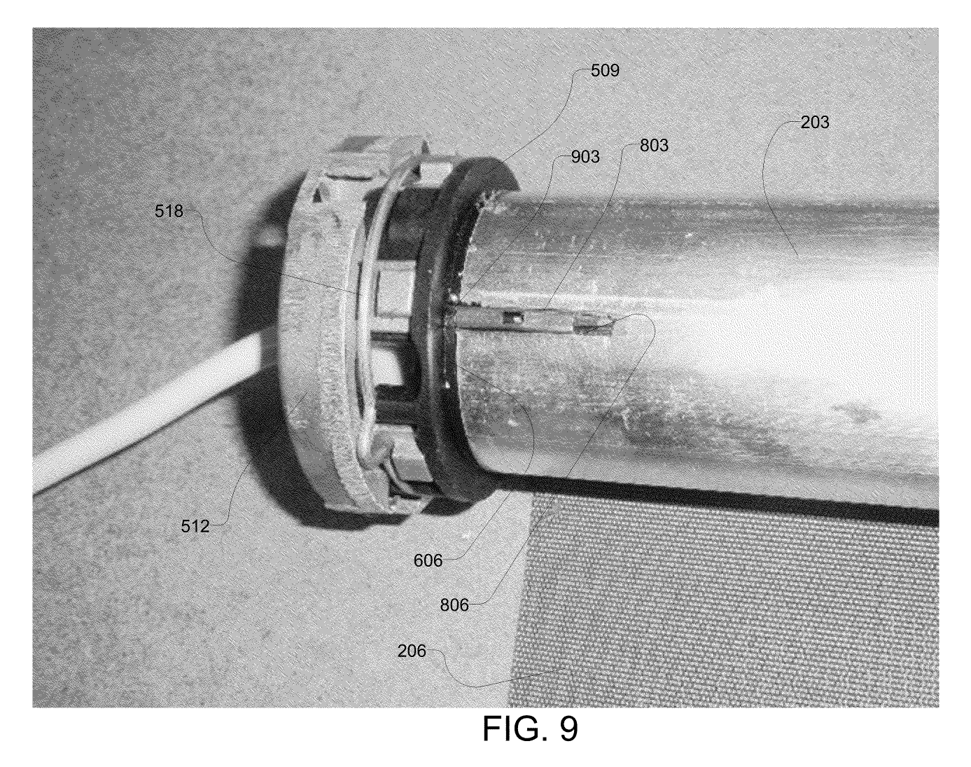

FIG. 9 shows a detailed perspective view of the head bracket 512 secured to the head 509 by the spring pin 515. Also, FIG. 9 shows the clip 803, which may take the form of a reinforcing piece of formed sheet metal that engages structure 903 on the first end cap 606 and engages the slot 806 of the blind rod 203. The clip 803 has a thickness that causes increased interference and friction to facilitate securing the motor 503 within the blind rod 203. Other structure may be alternatively or additional used to secure the motor housing against rotational and/or axial movement within the blind rod 203.

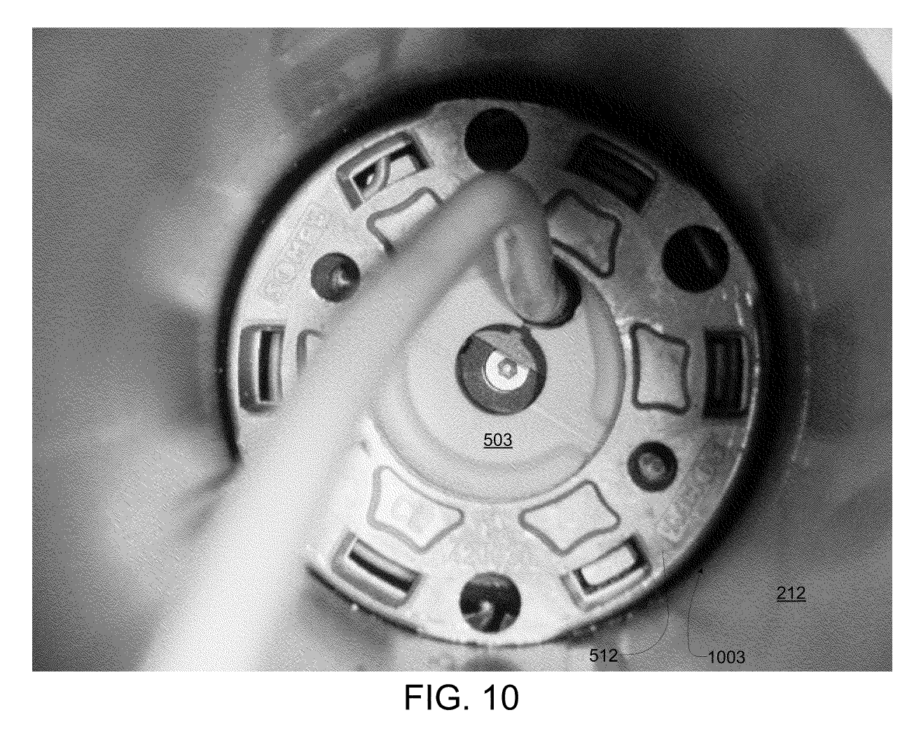

FIG. 10 is a perspective end view of the motor 503 held inside the drapery tube 212 by the head bracket 512. A setscrew 709 (shown in FIG. 7) may be utilized to bridge a gap 1003 and fix the motor head 509 via the motor head bracket 512 to the interior of the drapery tube 212.

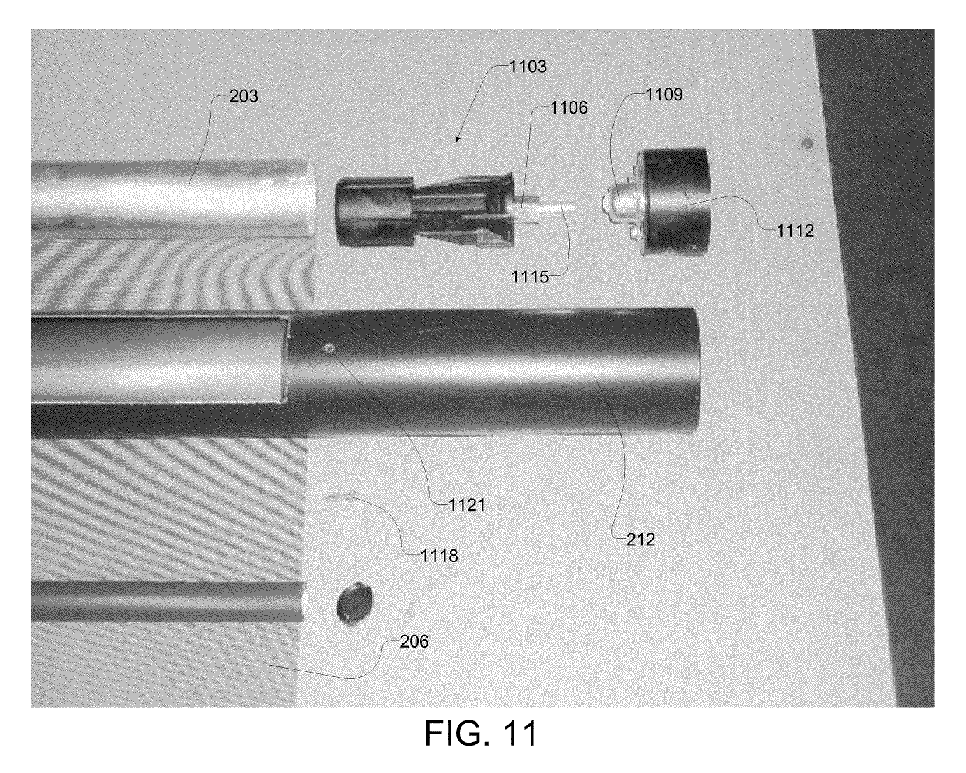

FIG. 11 is an exploded partial perspective view of an end of the blind rod 203 and an end of the drapery tube 212 that are opposite to the ends in which the motor 503 is installed. A core of the motor 503 fixed to the motor head 509 forms an axle for a first end of the blind rod 203. An end plug 1103 includes a spring-loaded retractable axle 1106 on the second end of the blind rod 203. The end plug 1103 is received into an interior of the blind rod 203 and secured thereto by one or more of friction, screws, and/or other coupling mechanisms. The end plug 1103 is secured in the second end of the blind rod 203 and a bearing 1109 is supported on an interior of the drapery tube 212 by a bearing base 1112. The bearing base 1112 can be secured within the drapery tube 212 by a screw 1118 engaged through hole 1121. Then a pin portion 1115 of the retractable axle 1106 can be inserted into a bearing 1109 during assembly.

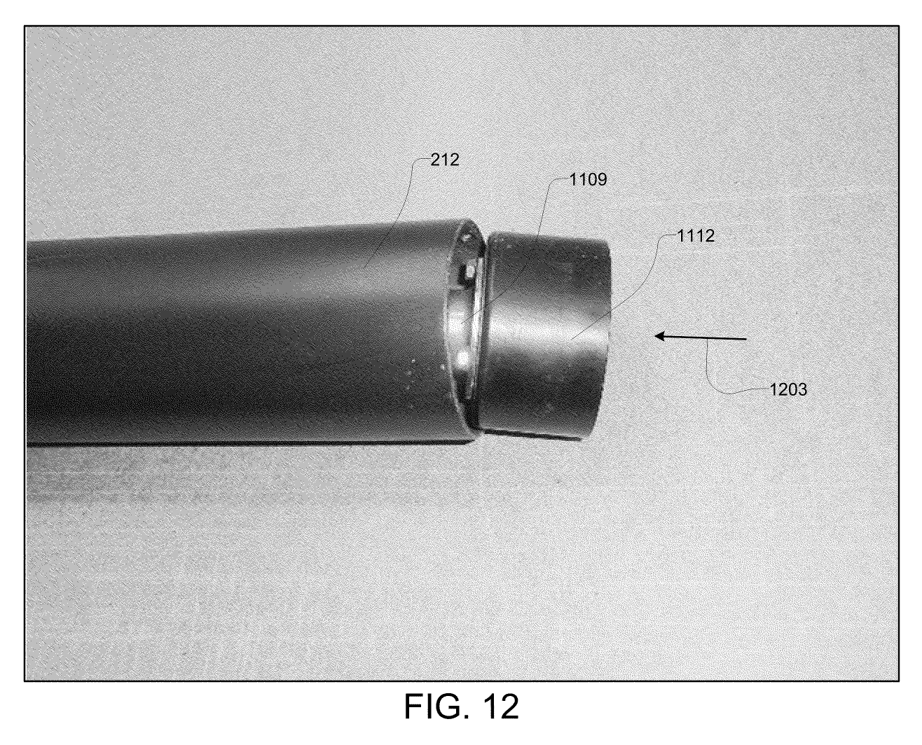

FIG. 12 is a partial perspective view of the bearing 1109 and the bearing base 1112 being inserted in a direction 1203 into an end of the drapery tube 212.

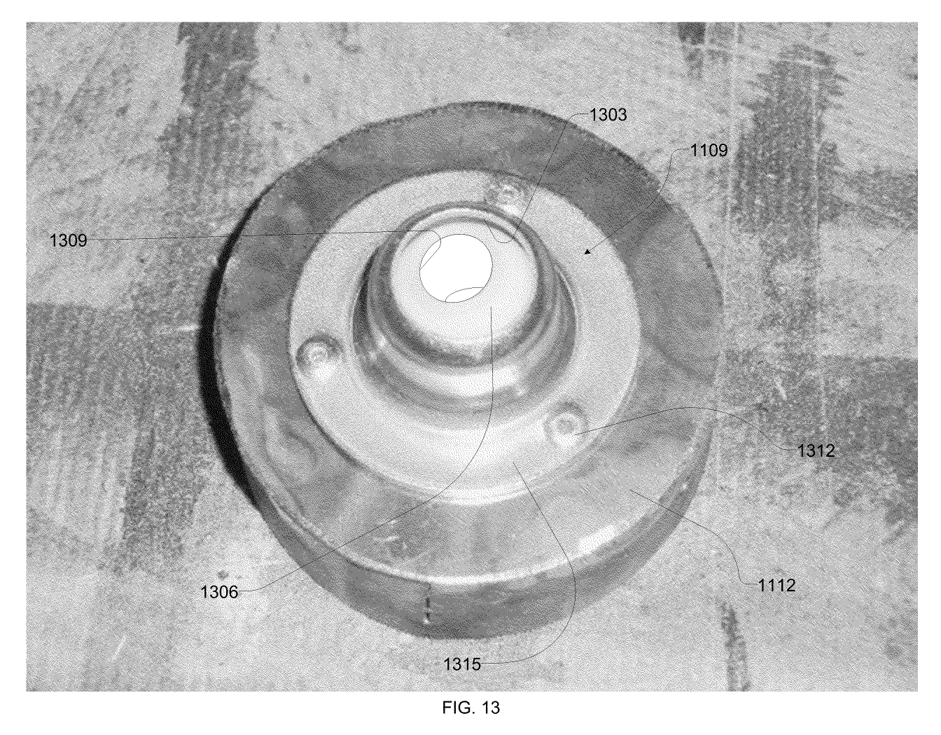

FIG. 13 is an internal end view of the bearing 1109 and the bearing base 11112 showing the bearing 1109 having a socket 1303 rotatably holding a ball 1306. The ball 1306 has an axle hole 1309 for receiving the pin 1115 of the axle 1106 (shown in FIG. 11). The socket 1303 may be secured to the base 1112 by fasteners 1312 extending through a flange 1315.

The bearing base 1112 can be a centering collar that positions the bearing 1109. The bearing base 1112 or centering collar thus centers the bearing and the inner tube or blind rod 203 on a central rotational axis within the outer tube or drapery tube 212. It is to be understood that the hand crank base 306, bearing 209, and motor head bracket 512 are also centering collars or may have supplemental centering collars associated therewith that function in the same way to help center the bearings or motor axes within the drapery tube 212. The position of the blind rod can be determined by providing the positioning collar of substantially the same size as an inner diameter of the outer tube 212 and positioning a bearing, drive crank, or motor at a center of the centering collar. Alternatively or additionally, one or more of set screws, spacers, sleeves, and other mechanisms can be combined with the centering collars 209, 306, 512, and 1112 to enable adjustment of the central position of the blind rod 203 within the drapery tube 212.

The centering collars 209, 306, 512, and 1112, or supplemental centering collars associated therewith also provide a lengthwise adjustment mechanism for positioning the ends of the blind rod 203 at any position along a length of the outer or drapery tube 212. The centering collars may have greater or lesser dimensions in an axial direction along the length of the drapery tube 212. Centering collars having longer lengths distribute loads over a larger portion of the inner surface of the outer tube 212.

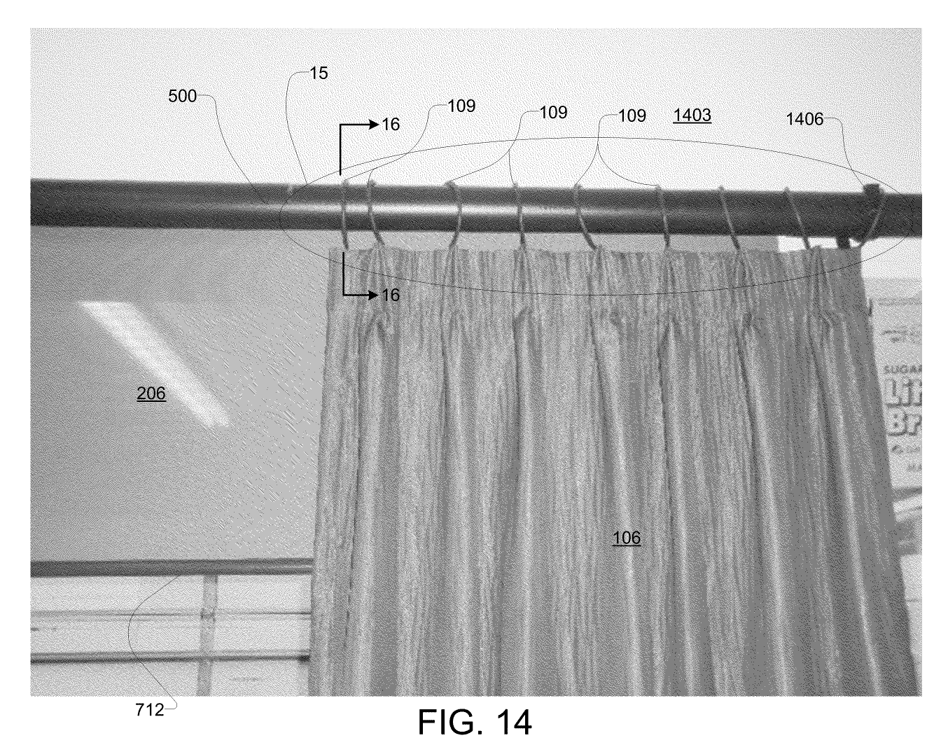

FIG. 14 is a front perspective view of the system including the combination drapery rod 500. Once the combination drapery rod 500 has been assembled, it can be secured to a wall by a bracket 1406, and a drapery 106 can be hung on the combination drapery rod 500 by a plurality of C-rings 109. As shown, the fabric 206 of the blind is partially extended from the slot 403 (not visible in FIG. 14), and is drawn downward by the hem weight 712 for a relatively flat shade or screen. The shade can be utilized of one or more of blocking light to darken a room, blocking a view for privacy, and creating a projection screen for viewing illuminated images from a projector. The combination drapery rod 500 with its blind may have additional applications without limitation.

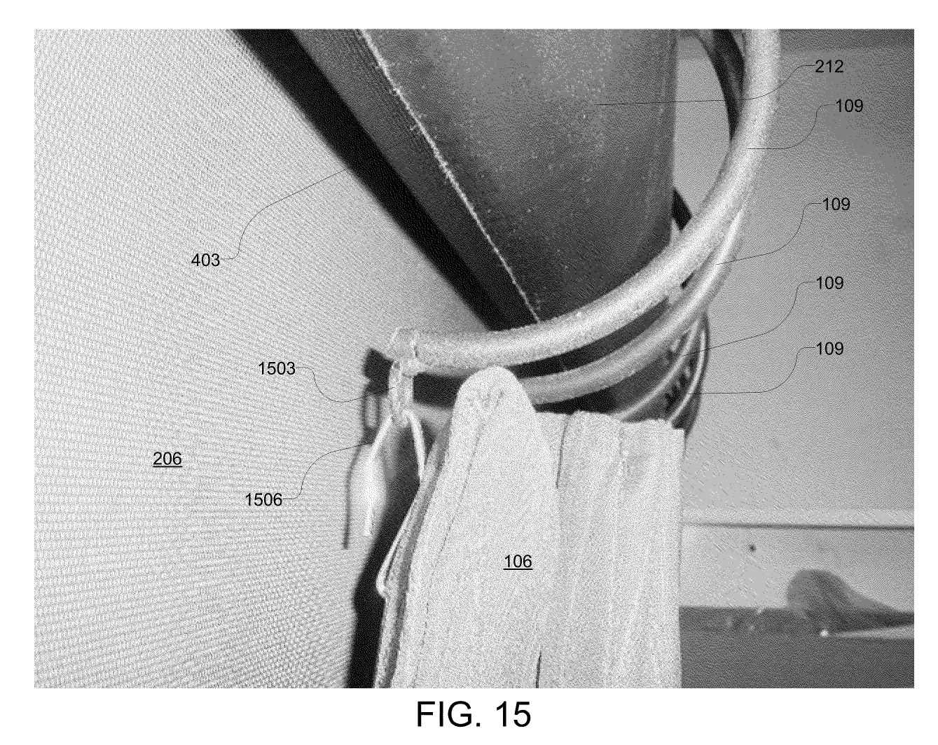

FIG. 15 is a perspective end view of an outlined region 15 of FIG. 14. The slot 403 having an edge near a bottom of the drapery tube 212 opens downwardly and rearwardly to generally conceal a blind portion of the combination drapery rod 500 when the blind is in a retracted condition. The slot 403 enables extension and retraction of the blind 206 by rolling, as shown and described herein. FIG. 15 also shows the C-rings 109, each of which has a loop 1503 secured at its lower end for receiving and holding a drapery hook 1506. The C-rings 109 can be slid along the drapery tube 212 manually or by a curtain or drapery motor 110 (illustrated in FIG. 1). The drapery 106 can be moved independently of operation of the blind.

Alternatively, in some embodiments, the drapery can be moved only when the blind is in a certain position. For example, when the fabric 206 is retracted then the motor 110 and related structure for automated movement of the draperies 106 can be undertaken. On the other hand, in another embodiment, the draperies 106 can only be moved when the fabric 206 is extended, in which case the drapery tube is less occupied since the roll of fabric becomes smaller as the fabric 206 is extended from within the drapery tube 212. In other configurations, both the draperies 106 and the blind 200 can be operated independently without interfering with each other for maximum utility in an aesthetically pleasing integral combination. FIG. 15 shows the drapery 106 aesthetically and structurally well supported at a position generally directly below a bottom center of the drapery tube 212. This position for the drapery 106 corresponds to a position for the loops 1503 and drapery hooks 1506 being located slightly to the rear of center below the drapery tube 212.

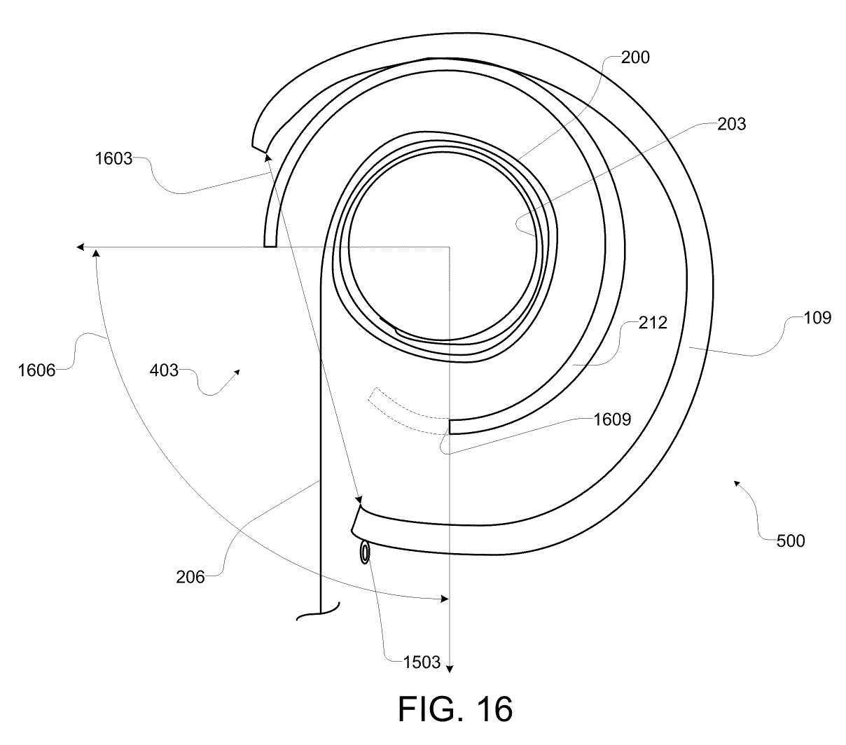

FIG. 16 is a diagrammatic partial sectional view taken along line 16-16 of FIG. 14 showing similar structural relationships to those shown in FIG. 15 and further depicting additional details. For example, the C-ring 109 is shown slidably engaging at a top position on the drapery tube 212. The loop 1503 may be fixed or otherwise secured to a lower end of the C-ring 109. As shown, a gap between arcuate ends of the C-ring has a dimension 1603, which may be sized at least slightly larger than an outer diameter of the drapery tube 212 in order to be easily installed on or removed from the drapery tube 212. Alternatively, the dimension 1603 may be smaller than the outer diameter of the drapery tube, but may easily slip axially over an end of the drapery tube 212 or over a portion of an ornamental end cap that has a dimension smaller than the dimension 1603 for hanging the drapery thereon. In another embodiment, the arc of material that has been removed to form the slot 403 reduces a dimension of the drapery tube in a direction normal to the slot opening such that it is smaller than the dimension 1603 for facilitating installation and removal of the C-rings relative to the drapery tube 212 even though the dimension 1603 may be smaller than the diameter of the drapery tube 212. An arc of the C-rings and the offset from the center of the drapery tube 212 caused by the drapery hooks 1506 when they have the weight of draperies on them may be such that the loops 1503 hang naturally between the center (in a front to back direction) and the fabric 206 of the blind 200.

In this regard, the slot 403 may have an opening extending through an arc having an angle of approximately 90 degrees. In a broad range the slot 403 may have an opening with an arc extending circumferentially in a range from 5 degrees to 180 degrees. In a moderate range, the slot 403 may have an opening with an arc of 45 degrees to 135 degrees. In a narrower range, the slot 403 may have an opening with an arc in a range from 60 degrees to 120 degrees. In one case, the slot may have an opening that is only slightly larger in a circumferential direction than a thickness of the fabric 206. A position of the slot may be centered at approximately 7:30, as viewed in FIG. 16. Alternatively, the slot may be centered at any arcuate position in a range from 5:30 to 10:00. A moderate range for the arcuate center of the slot 403 may be from 6:30 to 8:30. A narrower range may be from 7:00 to 8:00 for the arcuate center of the slot 403 along the circumference of the drapery tube 212.

As shown in FIG. 16, the slot 403 is large enough to permit passage of the fabric 206 through the slot 403 whether the fabric 206 is rolled completely on, completely off or anywhere between the on and the off condition without interference between the fabric 206 and an edge of the opening forming the slot 403. In other embodiments, slight interference between the fabric 206 and an edge of the opening forming the slot 403 may occur during rolling or unrolling. For increased concealment of the blind 200 in its retracted condition, a lower edge 1609 of the opening forming the slot 403 may be extended to a higher and more rearward position, such as at 7:00 or 7:30. In this way, a person positioned in front and slightly below the combination drapery rod 500 will not be able to readily observe the slot 403.

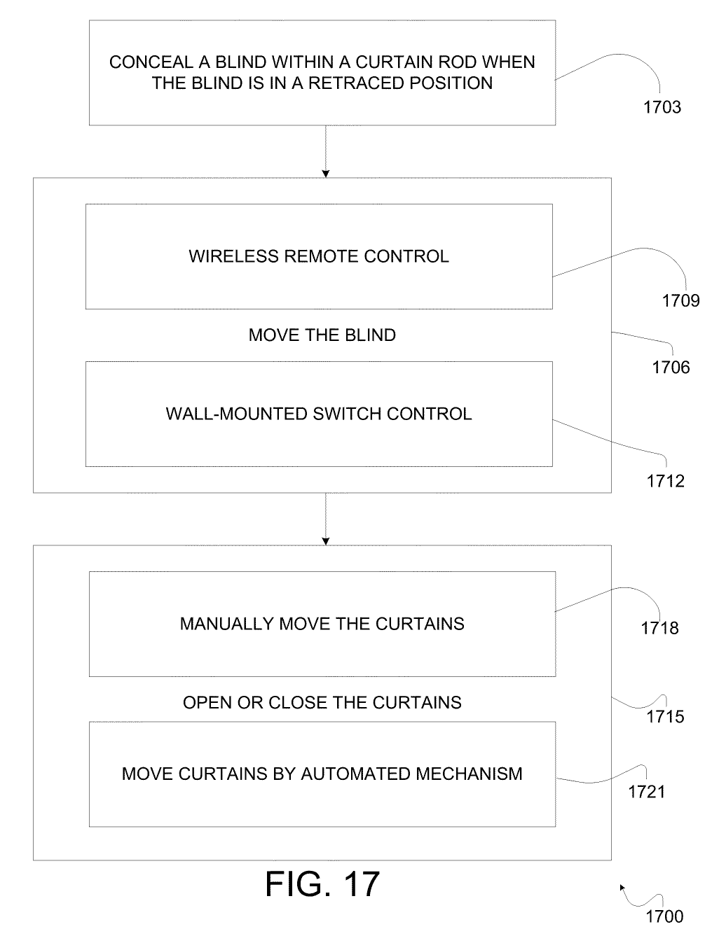

FIG. 17 is a schematic block diagram of an embodiment 1700 of a method of using a combination drapery rod. A user conceals a blind within a drapery rod by moving the blind to a retracted position, as indicated at 1703. The embodiment 1700 also includes moving the blind in either an extending or retracting direction, as indicated at 1706. Moving the blind may include wirelessly controlling a motor or other motive mechanism through a portable remote control device for moving the blind, as indicated at 1709. Alternatively or additionally, moving the blind may include controlling the blind through a wired or wireless wall-mounted control, as indicated at 1712.

The method 1700 may also include opening or closing draperies supported on the combination drapery rod, as indicated at 1715. Opening and closing the draperies may include manually moving the draperies, as indicated at 1718, or moving the draperies by an automated mechanism, as indicated at 1721. Moving the draperies by an automated mechanism may include moving the draperies through operation of a portable remote control device and/or through operation of a wall-mounted control that is either wired or wireless.

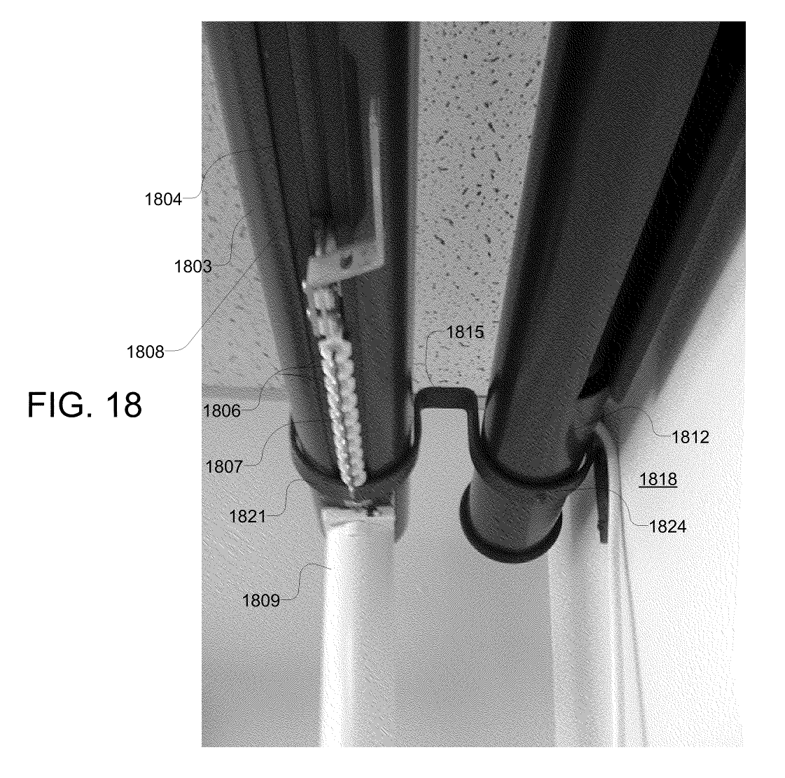

FIG. 18 is a bottom perspective view of a motorized decorative drapery tube 1803 having a drapery rod 1804 concealed within the tube 1803 and sliding elements 1806 with eyelets 1807 protruding downward through a slot 1808 in the tube 1803. In this way, the drapery rod 1804 and a motor 1809 can be concealed by the drapery tube 1803 and the drapery (not shown in FIG. 18.) While shown in combination with a blind tube 1812, the motorized decorative drapery tube 1803 may be utilized by itself and may be supported by a bracket by itself without an adjacent blind tube 1812, for example.

In FIG. 18, a bracket 1815 is attached to a wall 1818 and supports the motorized decorative drapery tube 1803 in a forward yoke 1821. The bracket 1815 also includes a rearward yoke 1824, which in the embodiment of FIG. 18 supports the blind tube 1812. The blind tube 1812 may include the retractable blind in accordance with any of the embodiments described herein. For example, the blind tube 1812 may be substantially similar to the combination drapery rods 103, 500 of FIGS. 1-16.

The combination of decorative tubes 1803 and 1812 in FIG. 18 has the advantage of an aesthetically appealing presentation for any viewer. The blind tube is at least partially hidden by the motorized decorative drapery rod 1803 when a drapery is opened. Furthermore, when the drapery is closed, the blind tube 1812 and any blind extending therefrom is also concealed. The combination has many of the same or similar advantages as does a combination of motorized blind and motorized drapery in a common outer decorative tube described above.

Other mechanisms for moving the blind and/or draperies may be utilized instead of or in addition to those described herein. It is also to be understood that the operation of the movement of the blind may be independent of movement and/or position of the draperies or may be dependent on the movement and/or position of the draperies. Similarly, the movement of the draperies may be independent of movement and/or position of the blind or may be dependent on the movement and/or position of the draperies. In one example, a limit switch is located to permit movement of the draperies only after the blind has reached a fully extended or a fully retracted position.

Features of the embodiments of the present invention may be mixed and matched in any combination without departing from the spirit and scope of the present invention.

It is to be understood that the wall-mounted control or the remote-control device may be configured to control blinds and/or draperies on a plurality of windows, such as for all of the windows in any given room, set of rooms, or throughout an entire house or other building.

Any of a variety of motors may be utilized in conjunction with embodiments of the present invention. One example of a motor that can be used is an electric motor model No. LT 50 Altus Rts., manufactured by Somfy of Brea, Calif. 92821. Other brands and models of motors may be used within the spirit and scope of the present invention.

Any sheer or opaque fabric may be used for the blind. One example of a fabric usable for the blind is a product called Sheer Weave 2000 made by Phifer of Tuscalusa, Ala. 35403. Other fabrics, woven and nonwoven, light permeable and opaque, or combinations thereof may be used without limitation.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for combining a drapery rod and a roller blind, the apparatus comprising:
a drapery rod including an outer tube adapted to receive slidable hanging elements for supporting a drapery;
an inner tube rotatably supported within the outer tube, the inner tube adapted to have a rollable fabric connected thereto; and
an electric motor supported on an inside of the outer tube and motively engaging the inner tube to rotate the inner tube relative to the outer tube during operation.

2. The apparatus of claim 1, further comprising mounting brackets coupled to the outer tube, the mounting brackets adapted for mounting the drapery rod to a wall.

3. The apparatus of claim 1, further comprising a control operably connected to the electrical motor for operating the drapery rod to roll the fabric onto and unroll the fabric off of the inner roller.

4. The apparatus of claim 3, wherein the control comprises a wall-mounted switch.

5. The apparatus of claim 3, further comprising a receiver disposed within the outer tube and operably connected to the motor; wherein the control comprises a wireless portable remote control device having a transmitter and switches therein for communication with the receiver.

6. The apparatus of claim 1, wherein the motor is located outside the inner tube.

7. The apparatus of claim 1, wherein the motor is cylindrical and is aligned along a common cylindrical axis with the inner tube.

8. The apparatus of claim 7, wherein the motor is received within the inner tube.

9. The apparatus of claim 1, wherein the drapery rod is a first drapery rod, the apparatus further comprising a second drapery rod supported adjacent to the first drapery rod, the second drapery rod having slidable hanging elements for supporting a drapery.

10. The apparatus of claim 9, wherein the inner tube is a first inner tube, the apparatus further comprising a second inner tube concealed within the second drapery rod, the second inner tube slidably supporting the slidable hanging elements.

11. The apparatus of claim 9, wherein the second drapery rod is a motorized drapery rod.

12. The apparatus of claim 9, further comprising mounting brackets coupled to and supporting the first and second drapery rods, the mounting brackets adapted for mounting the first and second drapery rods to a wall.

13. A system for movably supporting a drapery and a rollable blind on a combination drapery rod, the system comprising:
an outer tube supporting a driving mechanism and an inner tube on an interior of the outer tube;
the outer tube having a slot extending from the interior to an exterior of the outer tube along a length of the outer tube;
the inner tube having a fabric attached thereto for extending through the slot, the inner tube being drivably coupled to the driving mechanism and forming a retractable blind within the outer tube; and
the outer tube adapted for slidably receiving drapery-supporting elements;
wherein the combination drapery rod forms a monolithic combination drapery rod that has the appearance of a conventional drapery rod for supporting slidable hanging elements of a drapery while housing the drive mechanism, the inner tube, and the fabric forming the retractable blind.

14. The system of claim 13, wherein the drive mechanism comprises an electric motor supported on an interior of the outer tube and motively coupled to the inner tube.

15. The system of claim 14, further comprising a wireless connection between the motor and a user interface.

16. The system of claim 15, wherein the wireless connection comprises a receiver, a transmitter, and an electronic controller associated with the wireless connection.

17. The system of claim 13, further comprising an attachment mechanism configured to couple the outer tube to a wall or other structure.

18. The system of claim 13, wherein the outer tube is a first outer tube, the system further comprising a second outer tube supported adjacent to the first outer tube, the second outer tube slidably receiving drapery-supporting elements.

19. The system of claim 18, wherein the inner tube is a first inner tube, the system further comprising a second inner tube on an interior of the second outer tube, the second inner tube comprising a channel slidably supporting the drapery-supporting elements.

20. A method for deploying and retracting a blind, the method comprising:
concealing a blind within a drapery rod when the blind is in a retracted position; and
moving the blind on or off a blind rod within a drapery rod in response to user input;
wherein the concealing and moving are at least one of dependent and independent of opening and closing draperies associated with the blind.

21. The method of claim 20, wherein moving the blind comprises operating an electric motor disposed within the drapery rod.

22. The method of claim 21, wherein operating the electric motor comprises operating the motor by remote control through a wireless connection.

23. The method of claim 21, wherein operating the electric motor comprises operating the motor through a wall-mounted switch.

24. The method of claim 20, further comprising at least one of opening and closing draperies supported on the drapery rod.

25. The method of claim 24, wherein the at least one of opening and closing the draperies comprises moving the draperies by an automated mechanism.

26. The method of claim 20, wherein the drapery rod is a first drapery rod, the method further comprising at least one of opening and closing draperies supported on a second drapery rod separate from and adjacent to the first drapery rod.

27. The method of claim 20, wherein the concealing and moving are independent of at least one of opening, closing, and moving draperies associated with the blind.

28. The method of claim 20, wherein the concealing and moving are dependent on at least one of opening, closing, and moving draperies associated with the blind.

29. The method of claim 28, wherein moving the draperies is dependent on at least one of extending, concealing, retracting, and moving the blind.
